(19) United States
(12) Patent Application Publication
(10) Pub. No.: US 2024/0117253 A1
(43) Pub. Date: Apr. 11, 2024

(54) PROCESS TO CONTINUOUSLY PREPARE A CHAR PRODUCT

(71) Applicant: TORRGAS TECHNOLOGY B.V., Amsterdam (NL)

(72) Inventor: Robert Hugo Berends, Amsterdam (NL)

(73) Assignee: TORRGAS TECHNOLOGY B.V., Amsterdam (NL)

(21) Appl. No.: 18/368,670

(22) Filed: Sep. 15, 2023

(30) Foreign Application Priority Data
Oct. 11, 2022 (NL) 2033276

(51) Int. Cl. C10B 53/02; C10B 47/20

(52) U.S. Cl. CPC C10B 53/02; C10B 47/20

(57) ABSTRACT

The invention is directed to a process to continuously prepare a char product having a high BET surface area of above 400 m2/g and gaseous fraction comprising of carbon monoxide, hydrogen and hydrocarbons starting from particles of a torrefied biomass in an elongated and substantially horizontally positioned reactor furnace. A reactive gaseous mixture of steam and oxygen is supplied to the solids in the reactor and more oxygen and steam is supplied to the downstream end part of the reactor as compared to the amount of oxygen supplied to the upstream end part.

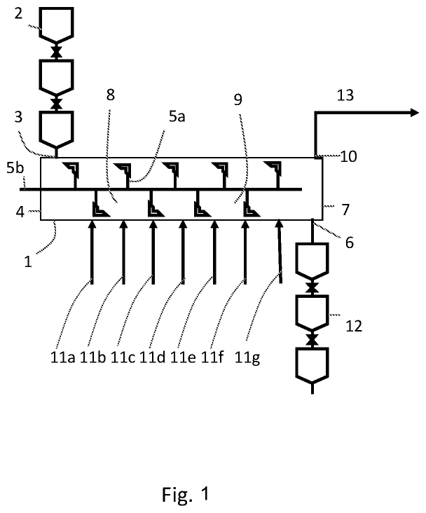

### CROSS-REFERENCE TO RELATED APPLICATIONS

This application claims benefit under 35 U.S.C. § 119(a) of NL Provisional Application No. 2033276 filed Oct. 11, 2023, the contents of which are incorporated herein by reference in their entirety.

The invention is directed to a process to continuously prepare a char product having a high BET surface area of for example above 400 m2/g and gaseous fraction comprising of carbon monoxide, hydrogen and hydrocarbons starting from particles of a torrefied biomass having a volatile content of between 60 and 80 wt %.

Such a process is described in WO2020/055254. This publication describes a process to prepare a char product having a high BET surface area and synthesis gas. Pellets of torrefied wood having a volatiles content of 70 wt % are contacted with a mixture of steam and oxygen in a tubular reactor at temperatures ranging from 520 to 640 C. A char product was prepared having a BET surface area of 440 m2/g at the higher temperature. The solids continuously moved from an inlet to an outlet in the horizontally positioned reactor. Along the length of the reactor a mixture of oxygen and steam is added. A gaseous fraction as obtained in the tubular reactor is subjected to a partial oxidation in the absence of the char product to prepare a synthesis gas of chemical grade quality.

The process of WO2020/055254 has many advantages. Nevertheless there is a need to further improve this process. There is a special desire to prepare a char product having a high BET surface area and to improve the yield of the gaseous fraction in the tubular reactor. A higher yield of gaseous fraction will consequently also result in a higher yield of synthesis gas.

This aim is achieved by the following process. Process to continuously prepare a char product having a high BET surface area and gaseous fraction comprising of carbon monoxide, hydrogen and hydrocarbons starting from particles of a torrefied biomass having a volatile content of between 60 and 80 wt %, wherein
the particles are fed to one end of an elongated and substantially horizontally positioned reactor furnace and moved within the reactor to an outlet for the char product at an opposite end of the elongated reactor defining a solids pathway zone in the reactor furnace having an upstream end part and a downstream end part of equal length,
wherein the gaseous fraction comprising of carbon monoxide, hydrogen and hydrocarbons is separated from the char product within the reactor furnace and discharged from the reactor furnace at the opposite end of the elongated reactor via an outlet for the gaseous fraction,
wherein the temperature in the reactor furnace is between 400 and 800° C. and the solid residence time in the solids pathway zone is between 10 and 80 minutes,
wherein the particles of the torrefied biomass are contacted in the solids pathway zone with a reactive gaseous mixture comprising of steam and oxygen and wherein the total amount of oxygen as supplied to the reactor furnace is between 0.1 and 0.4 kg per kg of particles of a torrefied biomass as supplied to the reactor and wherein the average oxygen to steam molar ratio of the reactive mixture is between 1:5 and 1:1,
wherein the reactive gaseous mixture of steam and oxygen is supplied to the upstream end part and to the downstream end part of the solids pathway, and
wherein more than 55%, more preferably more than 57% and even more preferably more than 60% of the combined oxygen and steam as supplied as part of the reactive gaseous mixture to the reactor furnace is supplied to the downstream end part and the remaining oxygen is provided to the upstream end part.

Applicants found that when relatively more oxygen and steam is supplied to the downstream end part of the reactor a char product is obtained with a higher BET surface area. Further less of this product is obtained which means that the yield of gaseous fraction is increased.

The terms used as downstream end part and the upstream end part having equal length can be any part of the solids pathway zone. The length is defined as the distance in the axial direction of the elongated furnace reactor. Suitably the downstream end part and the upstream end part having equal length divide the solids pathway zone in two parts of equal length.

Preferably the amount of oxygen supplied to the downstream end part is higher than the amount of oxygen supplied to the upstream end part is so chosen that a relative low temperature of the gaseous fraction as discharged from the reactor furnace is achieved. Preferably this temperature is below 550° C. and more preferably the temperature of the gaseous fraction as discharged from the reactor furnace is between 450 and 500° C. The average temperature in the reactor furnace may be higher and preferably the temperature at the point where the upstream end part and a downstream end part meet is between 550 and 800° C., more preferably between 550 and 700° C. At these temperatures the ash compounds as present in the torrefied biomass will not melt and thus will not form an undesirable slag. Instead the ash compounds remain in the char product and can be recycled to the biomass growth chain when the char particles are used as a fertiliser or as a soil enhancer.

Preferably more than 57% and even more preferably more than 60% of the combined oxygen and steam as supplied as part of the reactive gaseous mixture to the reactor furnace is supplied to the downstream end part and the remaining oxygen is provided to the upstream end part. The combined amount is expressed in mass.

The temperature in the reactor furnace may results from the heat of the partial oxidation reactions, the heat supplied to the reactor furnace, for example via the supplied reactive gasses or via heat exchange via the walls of the reactor furnace, and from heat sinks such as evaporation of material from the particles of torrefied biomass and endothermic reactions, for example on the surface of the formed char product. Preferably the temperature of the reactive gas as it is supplied to the reactor furnace is between 200 and 400° C., preferably between 250 and 350° C. It is found that under these conditions, ie supplying the described reactive gas, the temperature in the reactor furnace can be kept in the preferred ranges and no heat exchange via the walls of the reactor furnace is required.

In the process the particles of the torrefied biomass are contacted in the solids pathway zone with a reactive gaseous mixture comprising of steam and oxygen and wherein the total amount of oxygen as supplied to the reactor furnace is between 0.1 and 0.4 kg per kg of particles of a torrefied biomass as supplied to the reactor. The average oxygen to steam molar ratio of the reactive mixture is between 1:5 and 1:1 and preferably between 1:3 and 1:1. Preferably the oxygen to steam molar ratio of the reactive mixture as supplied to the different inlet nozzles is the same in order to simply the process. This ratio may however also be different and preferably between the above ranges wherein the reactive gas as supplied to one or more downstream inlet nozzles is relatively higher as compared to the reactive gas as supplied to the upstream inlet nozzle or nozzles.

The reactive mixture is suitably prepared by mixing super heated steam with substantially pure oxygen. The required purity of the oxygen may depend on the allowable impurities, like for example nitrogen and argon, in the gaseous mixture or synthesis gas which is to be prepared by this process. The oxygen preferably has a purity of at least 90 vol %, more preferably at least 94 vol %, wherein nitrogen, carbon dioxide and argon may be present as impurities. Such substantially pure oxygen is preferred because a syngas containing lower amounts of nitrogen may be obtained. Such substantially pure oxygen may be prepared by well known processes, such as an air separation unit (ASU), pressure swing absorber (PSA) or by a water splitter, also referred to as electrolysis.

The reactive gaseous mixture is suitably supplied to the upstream end part and to the downstream end part via axially spaced nozzles. These nozzles are preferably placed in the lower end of the reactor furnace. In this manner an optimal contacting is achieved with the particles as they are moved within the reactor in the solids pathway zone. The nozzles may be metal nozzles.

The elongated reactor furnace may be a so-called rotary kiln reactor provided with a gas distributor for the reactive gaseous mixture as for example described in US2017/0275542, US2011/0116984 and U.S. Pat. No. 4,318,713. These publications show a reactor where a reactive gaseous mixture can be supplied to a solid pathway zone at different axial positions. Alternatively an elongated reactor may be used having rotating means within the furnace. Thus contrary to the rotary kiln reactors the reactor vessels are fixed and do not rotate. Rotating means may be an axle positioned axially in a tubular reactor furnace provided with radially extending arms which move the particles of torrefied biomass axially in the solids pathway zone to the outlet for the char product when the axle rotates.

The above rotary and fixed reactors may be provided with a heated mantle to further maintain the desired temperature within the reactor. Examples of such a heated mantle are described in DE19720417. Preferably the reactors are provided with insulation instead of an heated mantle.

Torrefaction is a well-known process and for example described in WO2012/102617 and in the earlier referred to publication of Prins et al. in Energy and is sometimes referred to as roasting. In such a process the biomass is heated to an elevated temperature, suitably between 260 and 310° C. and more preferably between 250 and 290° C., in the absence of oxygen. Torrefaction conditions are so chosen that hemicelluloses decomposes while keeping the celluloses and lignin mostly intact. These conditions may vary for the type of biomass material used as feed. The temperature and residence time of the torrefaction process is further preferably so chosen that the resulting material has a high content of so-called volatiles, i.e. organic compounds. The solids residence time is suitably at least 5 and preferably at least 10 minutes. The upper residence time will determine the amount of volatiles which remain in the torrefied biomass. The content of volatiles is between 60 and 80 wt % and more preferably between 65 and 75 wt %. The volatile content is measured using DIN 51720-2001-03. Applicants found that the relatively high volatile content in the torrefied biomass is advantageous to achieve a high syngas yield.

Preferably the torrefied biomass has an atomic hydrogen over carbon (H/C) ratio of between 0.7 and 1.3, preferably between 1 and 1.2 and an atomic oxygen over carbon (O/C) ratio of between 0.4 and 0.8. Further the water content will reduce in a torrefaction process. The particles of a solid torrefied biomass suitably contain less than 7 wt %, and more preferably less than 4 wt % water, based on the total weight of the solid torrefied biomass.

In the torrefaction process the atomic hydrogen over carbon (H/C) ratio and the atomic oxygen over carbon (O/C) ratio of the biomass material is reduced. The hydrogen over carbon (H/C) ratio is suitably reduced by more than 70% and the atomic oxygen over carbon (O/C) ratio is suitably reduced by more than 80% in the reactor furnace when comparing the particles of the torrefied biomass and the char product.

The biomass material to be torrefied may be any material comprising hemicellulose including virgin biomass and waste biomass. Virgin biomass includes all naturally occurring terrestrial plants such as trees, i.e. wood, bushes and grass. Waste biomass is produced as a low value by-product of various industrial sectors such as the agricultural and forestry sector. Examples of agriculture waste biomass are corn stover, sugarcane bagasse, beet pulp, rice straw, rice hulls, barley straw, corn cobs, wheat straw, canola straw, rice straw, oat straw, oat hulls and corn fibre. A specific example is palm oil waste such as oil palm fronds (OPF), roots and trunks and the by-products obtained at the palm oil mill, such as for example empty fruit bunches (EFB), fruit fibers, kernel shells, palm oil mill effluent and palm kernel cake. Examples of forestry waste biomass are pre-commercial trees and brush, tree tops, limbs and logging residues and saw mill and paper mill discards. For urban areas, the best potential plant biomass feedstock includes yard waste (e.g., grass clippings, leaves, tree clippings, and brush) and vegetable processing waste. Waste biomass may also be Specified Recovered Fuel (SRF) comprising lignocellulose.

The biomass material to be torrefied may be a mixture originating from different lignocellulosic feedstocks. Furthermore, the biomass feed may comprise fresh lignocellulosic compounds, partially dried lignocellulosic compounds, fully dried lignocellulosic compounds or a combination thereof.

In a torrefaction process chips of torrefied material are typically obtained when woody biomass is processed. These chips may be, optionally directly, used as the particles of a torrefied biomass in the present process. In situations where the torrefaction process is distant from where the process according to this invention is performed it may be desirable to transport the torrefied biomass as compressed particles of particles of a powder of a torrefied biomass. For this the afore mentioned chips are milled to a powder and then pressed into a compressed particles of a powder of a torrefied biomass. Suitably these compressed particles are used for transporting the material by trucks, trains and/or ship to the process of this invention where they can be directly used as feedstock without any substantial pre-treatment like milling.

The pellets of a solid torrefied biomass feed may thus be obtained by pressing the torrefied powder into a shape. Such pellets may have any shape, such as cylinders, pillow shape like in briquettes, cubes. Preferably the smallest distance from the surface of such a pellet to its centre is less than 10 mm. This is advantageous for mass transport within the pellet while performing the pyrolysis or mild gasification process. For example a suitable pellet may have the shape of a cylinder suitably having a diameter of between 5 and 12 mm and preferably between and 10 mm. The length of such cylinders may be between 5 and 80 mm, preferably between 40 and 80 mm and more preferably between 40 and 70 mm. Briquettes may have comparable dimensions. In order to increase the strength of such a particle starch may be added or more preferably some waste plastic as described in WO2021/084016. Adding waste plastic is advantageous because it results in more stronger pellets and in a higher yield of syngas next to that chemical recycling of waste plastics is made possible.

The char product is suitably obtained as a particle having a similar size as the starting particles. A portion of the particles may have broken in two parts and some in three parts. But on the whole a char product is obtained having shapes and sizes which make the product suited for various end uses.

The absolute pressure at which the process is performed may vary between 90 kPa and 10 MPa and preferably between 90 kPa and 5 MPa. Pressures at the higher end of these ranges are advantageous when the gaseous fraction is used to prepare syngas having such elevated or even higher pressures. Lower pressures are advantageous when a char particle is desired having an even higher active surface.

When the process is performed under pressure it is preferred that the particles of the torrefied biomass is increased in pressure in a sluicing system before being added to the reactor furnace. This pressurisation of the solid biomass may be performed in a lock hopper as described in U.S. Pat. No. 4,955,989 and US2011100274. Pressurisation may also be performed using a solids pump as for example described in U.S. Pat. No. 4,988,239 or US2009178336.

In the mild gasification a gaseous fraction comprising hydrogen, carbon monoxide and a mixture of gaseous organic compounds and a solid fraction comprising of char particles is obtained. The gaseous organic compounds may comprise of non-condensed organic compounds. These compounds range from methane to organic compounds having up to 50 carbon atoms and even more. The organic compounds include hydrocarbons and oxygenated hydrocarbons. The content of these organic compounds in the gaseous fraction may be greater than 15 wt % and even be between 40 to 70 wt %. The gaseous fraction may also contain sulphur, chlorine and/or nitrogen bound organic compounds.

The gaseous fraction as separated from the char product is preferably used as feedstock in a partial oxidation process to prepare syngas. In such a process the gaseous fraction is subjected to a partial oxidation. The partial oxidation is performed in the absence of the char products. In the partial oxidation the C1 and higher hydrocarbons and possible oxygenates as present in the gaseous fraction are mainly converted to hydrogen and carbon monoxide thereby obtaining a syngas containing no or almost no tars. The gaseous fraction is subjected to a partial oxidation at a temperature of between 1000 and 1600 C and preferably between 1100 and 1600 C, more preferably between 1200 and 1500° C., and at a residence time of less than 5 seconds, more preferably at a residence time of less than 3 seconds. The residence time is the average gas residence time in the partial oxidation reactor. The partial oxidation is performed by reaction of oxygen and optionally in the presence of steam, with the organic compounds as present in the gaseous fraction, wherein a sub-stoichiometric amount of oxygen relative to the combustible matter as present in the gaseous fraction is used.

The oxygen comprising gas used in the partial oxidation of the gaseous fraction is suitably of the same composition as the oxygen comprising gas as described for the mild gasification above. The total amount of oxygen fed to a mild gasification and to the partial oxidation of the gaseous fraction is preferably between 0.1 and 0.6 mass oxygen per mass biomass as fed to the mild gasification and more preferably between 0.2 and 0.5 mass oxygen per mass biomass as fed to the mild gasification.

A suitable partial oxidation process for is for example the Shell Gasification Process as described in the Oil and Gas Journal, Sep. 6, 1971, pp. 85-90. In such a process the gaseous fraction and an oxygen comprising gas is provided to a burner placed at the top of a vertically oriented reactor vessel. Publications describing examples of partial oxidation processes are EP291111, WO9722547, WO9639354 and WO9603345.

The figure shows an elongated reactor (1) in which the process according to the invention may be performed. The particles of a torrefied biomass are pressurised in a sluicing system (2) and fed to a solids inlet (3) at one end (4) of the elongated and horizontally positioned reactor furnace (1). The particles are moved within the reactor (1) by means of mixing arms (5a) extending from a rotating axle (5b) to an outlet (6) for the char product at an opposite end (7) of the elongated reactor (1). Between solids inlet (3) and outlet (6) for the char product a solids pathway zone is present having an upstream end part (8) and a downstream end part (9) of equal length. At the opposite end (7) the formed gaseous fraction comprising of carbon monoxide, hydrogen and hydrocarbons is separated from the char product within the reactor furnace and discharged from the reactor furnace via an outlet (10) for the gaseous fraction.

The particles of the torrefied biomass are contacted in the solids pathway zone with a reactive gaseous mixture comprising of steam and oxygen. The reactive gaseous mixture is separately supplied to the reactor via numerous nozzles (11a-11g) as placed along the length of the reactor (1). The nozzles are placed in both the upstream end part (8) and a downstream end part (9). This allows to supply more oxygen to the downstream end part (9) as compared to the amount of oxygen supplied to the upstream end part (8).

Further a sluicing system (12) is shown to obtain the char products at ambient conditions and a transfer line (13) to supply the gaseous fraction to a downstream process which is preferably a partial oxidation to prepare chemical grade synthesis gas.

What is claimed herein:

1. A method to continuously prepare a char product having a high BET surface area, and also a gaseous fraction comprising carbon monoxide, hydrogen, and hydrocarbons, the method comprising:
moving particles of a torrefied biomass having a volatile content of between 60 wt % and 80 wt from one end of an elongated and substantially horizontally positioned reactor furnace along a solids pathway zone in the reactor furnace to at least one char product outlet at an opposite end of the reactor furnace and at least one gaseous fraction outlet at the opposite end of the reactor furnace;
wherein the solids pathway zone comprises an upstream end part and a downstream end part, wherein the upstream end part and the downstream end part are of equal length;
whereby the char product is discharged at the char product outlet;
whereby the gaseous fraction comprising carbon monoxide, hydrogen, and hydrocarbons is separated from the char product in the reactor furnace, and the gaseous fraction comprising carbon monoxide, hydrogen, and hydrocarbons is discharged from the reactor furnace at the gaseous fraction outlet;
wherein the temperature in the reactor furnace is between 400° C. and 800° C.;
wherein the solid residence time in the solids pathway zone is between 10 minutes and 80 minutes;
wherein the particles of the torrefied biomass are contacted in the solids pathway zone with a reactive gaseous mixture comprising steam and oxygen;
wherein the total amount of oxygen supplied to the reactor furnace is between 0.1 kg and 0.4 kg per kilogram of particles of the torrefied biomass;
wherein the average molar ratio of oxygen to steam of the reactive mixture is between 1:5 and 1:1;
wherein the reactive gaseous mixture of steam and oxygen is supplied to the upstream end part and to the downstream end part of the solids pathway; and
wherein more than 55% of the combined amount of oxygen and steam as supplied as part of the reactive gaseous mixture to the reactor furnace is supplied to the downstream end part, whereas the remaining oxygen and steam is supplied to the upstream end part.

2. The method according to claim 1, wherein the temperature of the gaseous fraction as removed from the reactor furnace is lower than 550° C.

3. The method according to claim 2, wherein the temperature of the gaseous fraction as removed from the reactor furnace is between 450° C. and 500° C.

4. The method according to claim 3, wherein the temperature at the point where the upstream end part and a downstream end part join, is between 550° C. and 800° C.

5. The method according to claim 1, wherein the temperature of the reactive gas as supplied to the reactor furnace is between 200° C. and 400° C.

6. The method according to claim 1, wherein the reactive gaseous mixture is supplied to the upstream end part and to the downstream end part by means of axially mutually distanced nozzles.

7. The method according to claim 1, wherein the particles of the torrefied biomass are torrefied chips and/or compressed particles of a powder of a torrefied biomass, and
wherein the particles of the torrefied biomass have an atomic ratio of hydrogen to carbon (H/C) that lies between 1 and 1.3, as well as an atomic ratio of oxygen to carbon (O/C) that lies between 0.4 and 0.8.

8. The method according to claim 7, wherein the ratio of hydrogen to carbon (H/C) in the reactor furnace is reduced by more than 70%, and the atomic ratio of oxygen to carbon (O/C) in the reactor furnace is reduced by more than 80% when comparing the particles of the torrefied biomass with the char product.

9. The method according to claim 1, wherein the particles of the torrefied biomass are subjected to a pressure increase in a sluice system, before being added to the mild gasification reactor.

10. The method according to claim 1, wherein the BET surface area of the char product is higher than 400 m² per gram.

11. The method according to claim 1, wherein more than 60% of the combined amount of oxygen and steam as supplied to the reactor furnace as part of the reactive gaseous mixture is supplied to the downstream end part, whereas the remaining amount of oxygen and steam is supplied to the upstream end part.
